(19) United States
(12) Patent Application Publication
(10) Pub. No.: US 2013/0173119 A1
(43) Pub. Date: Jul. 4, 2013

(54) STEERING SYSTEM FOR MOTOR-DRIVEN VEHICLE

(71) Applicant: Kazuyuki Izawa, Shizuoka-ken (JP)

(72) Inventor: Kazuyuki Izawa, Shizuoka-ken (JP)

(73) Assignee: SUZUKI MOTOR CORPORATION, Shizuoka-ken (JP)

(21) Appl. No.: 13/821,442

(22) PCT Filed: Apr. 11, 2011
(86) PCT No.: PCT/JP2011/058972

§ 371 Date: Mar. 7, 2013

(30) Foreign Application Priority Data
Sep. 28, 2010 (JP) 2010-216837

(51) Int. Cl. B62D 6/02; B62D 6/00

(52) U.S. Cl. CPC B62D 6/02; B62D 6/001
USPC 701/41

(57) ABSTRACT

An object of the present invention is to provide a steering system for a motor-driven vehicle, which has steering operability equivalent to that of a vehicle mounted with a conventional internal combustion engine only, and has steering operability equivalent to an inherent one even during the time when fail-safe control of assist of steering force is carried out. To achieve this object, in the steering system for a motor-driven vehicle including a drive motor that is a power source for the motor-driven vehicle, a motor speed sensor for detecting the speed of the drive motor, a steering system for giving a steering angle to front wheels according to the steering angle of a steering wheel, a vehicle speed sensor for detecting the speed of the motor-driven vehicle, and a power steering controller that outputs an assist amount according to the steering of a passenger based on at least one of the output signals of the motor speed sensor and the vehicle speed sensor, as the speed of the motor-driven vehicle or the speed of the drive motor increases, the assist amount is made smaller.

### TECHNICAL FIELD

The present invention relates to a steering system for a motor-driven vehicle and, more particularly, to a technique for using a power steering system, which is used for a vehicle mounted with a conventional internal combustion type engine, for a motor-driven vehicle mounted with a drive motor using electricity as a driving source.

### BACKGROUND ART

In the power steering system for a conventional engine-driven vehicle, the assist amount has been controlled by a vehicle speed signal sent from the wheel speed and an engine speed signal (used for judging the vehicle runnable state). In an electric vehicle having no engine or a series hybrid vehicle in which the engine speed does not relate directly to the vehicle speed, it is necessary to develop a unique power steering that does not use the engine speed signal, so that the vehicles of these types have a problem in terms of manpower and cost for development. As a method for applying the power steering system for the engine-driven vehicle to the electric vehicle, there has been proposed a method in which in a READY state (the vehicle runnable state), a false engine speed signal that is greater than a specified speed (set at a value less than the idling speed of a conventional engine) is sent to the power steering system (refer to PTL 1).

### CITATION LIST

### Patent Literature

PTL 1: Japanese Unexamined Patent Application Publication No. 2010-81714

### SUMMARY OF INVENTION

### Technical Problem

Concerning the steering system for a conventional motor-driven vehicle, PTL 1 proposes a method for using a power steering system, which is used for a vehicle mounted with an engine (also referred to as an “internal combustion type engine”), is used for an electric vehicle and the like having no engine. This method is such that, during the time when a ready-on signal for making the running motor mounted on the electric vehicle in a drivable state is received, a false engine speed indicating a predetermined speed is developed, whereby this false engine speed can assist the steering force of a passenger.

At this time, if the false engine speed is greater than the specified speed, it is judged that the engine is being operated, and the power steering control according to the vehicle speed is carried out.

However, in a power steering system of a type in which fail-safe control based on the engine speed is carried out when the vehicle speed signal is lost as fail safe, there arises a disadvantage in that if the false engine speed signal has a fixed value, a fail-safe function equivalent to that of the engine-driven vehicle cannot be performed.

Hereunder, the disadvantages of PTL 1 are described in detail.

(1) PTL 1 does not give a description such that the false engine speed changes with a change in the speed of a drive motor, and there is a fear that a fixed steering force assist is always provided. In this state, it is possible that the steering operability equivalent to that of the vehicle mounted with the conventional engine only may not be attained.
(2) In the case in which, while the false engine speed signal is generated normally, the vehicle speed signal and the like are generated normally, the assist of steering force is performed, and in the case in which either one of the signals is lost, the assist of steering force cannot be performed.
(3) PTL 1 does not give a description concerning the fail-safe control.

The power steering system in which the assist amount of steering force is changed with a change in vehicle speed employs a fail-safe control technology in which in the case in which the vehicle speed signal cannot be obtained, the assist amount of steering force is determined based on the engine speed in place of the vehicle speed, and the assist of steering force is performed.

In the use of the power steering system used for the vehicle mounted with an engine for the motor-driven vehicle such as an electric vehicle, in order to attain the steering operability equivalent to that of the vehicle mounted with an engine, there is still a room for improvement.

An object of the present invention is to provide a steering system for a motor-driven vehicle, which has steering operability equivalent to that of a vehicle mounted with a conventional internal combustion type engine only, and has steering operability equivalent to an inherent one even during the time when fail-safe control of assist of steering force is carried out.

### Solution to Problem

Accordingly, to overcome the above-described disadvantages, the present invention provides a steering system for a motor-driven vehicle including a drive motor that is a power source for the motor-driven vehicle, a motor speed sensor for detecting the speed of the drive motor, a steering system for giving a steering angle to front wheels according to the steering angle of a steering wheel, a vehicle speed sensor for detecting the speed of the motor-driven vehicle, and a power steering controller that outputs an assist amount according to the steering of a passenger based on at least one of the output signals of the motor speed sensor and the vehicle speed sensor, characterized in that as the speed of the motor-driven vehicle or the speed of the drive motor increases, the assist amount is made less.

### Advantageous Effects of Invention

As explained in detail above, according to the present invention, in the steering system for a motor-driven vehicle including a drive motor that is a power source for the motor-driven vehicle, a motor speed sensor for detecting the speed of the drive motor, a steering system for giving a steering angle to front wheels according to the steering angle of a steering wheel, a vehicle speed sensor for detecting the speed of the motor-driven vehicle, and a power steering controller that outputs an assist amount according to the steering of a passenger based on at least one of the output signals of the motor speed sensor and the vehicle speed sensor, as the speed of the motor-driven vehicle or the speed of the drive motor increases, the assist amount is made smaller.

Therefore, the steering system used for a vehicle mounted with a conventional internal combustion engine only can be used for the motor-driven vehicle such as an electric vehicle, and further, the steering operability equivalent to that of the vehicle mounted with an internal combustion engine can be attained.

### BRIEF DESCRIPTION OF DRAWINGS

FIG. 1 is a schematic plan view of a steering system for a motor-driven vehicle. (embodiment)

FIG. 2 is a graph showing one example of false engine speed based on the speed of a motor. (embodiment)

### DESCRIPTION OF EMBODIMENTS

An embodiment of the present invention will now be described in detail with reference to the accompanying drawings.

### Embodiments

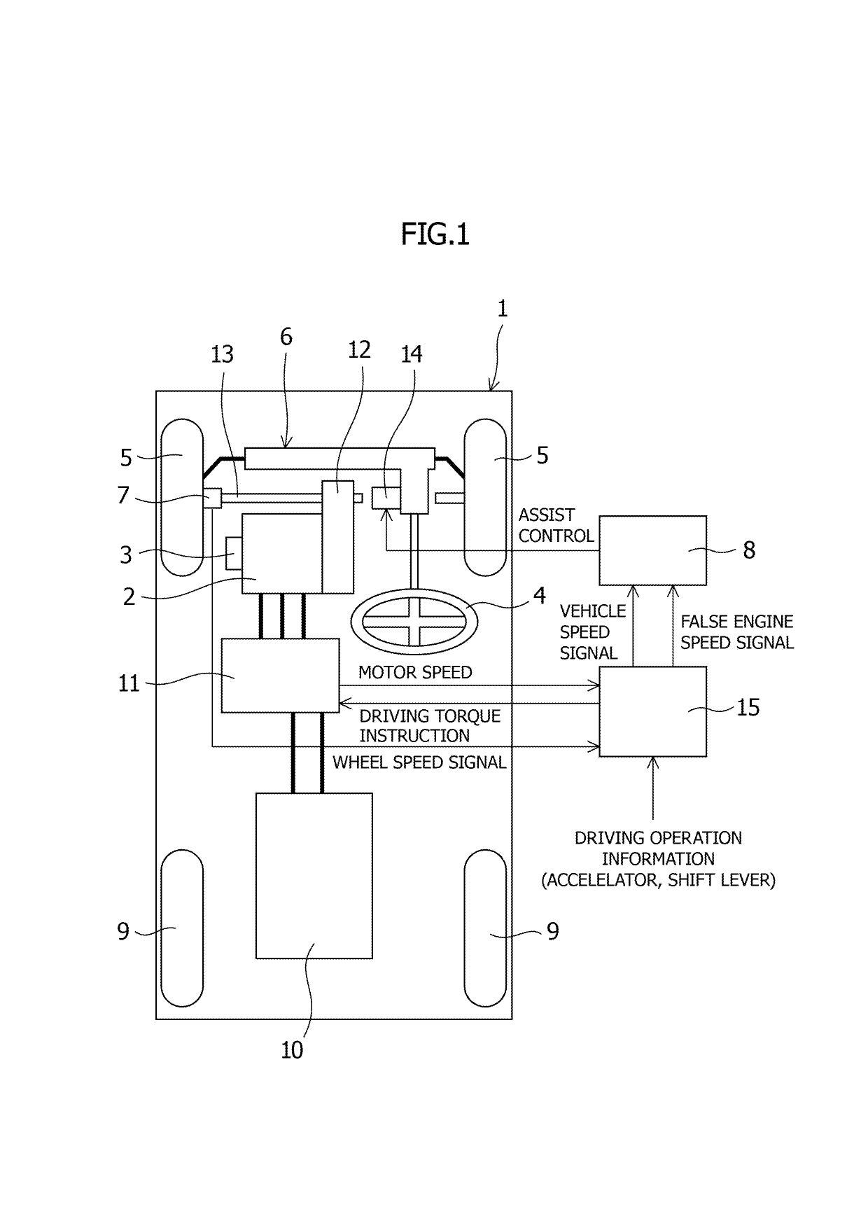

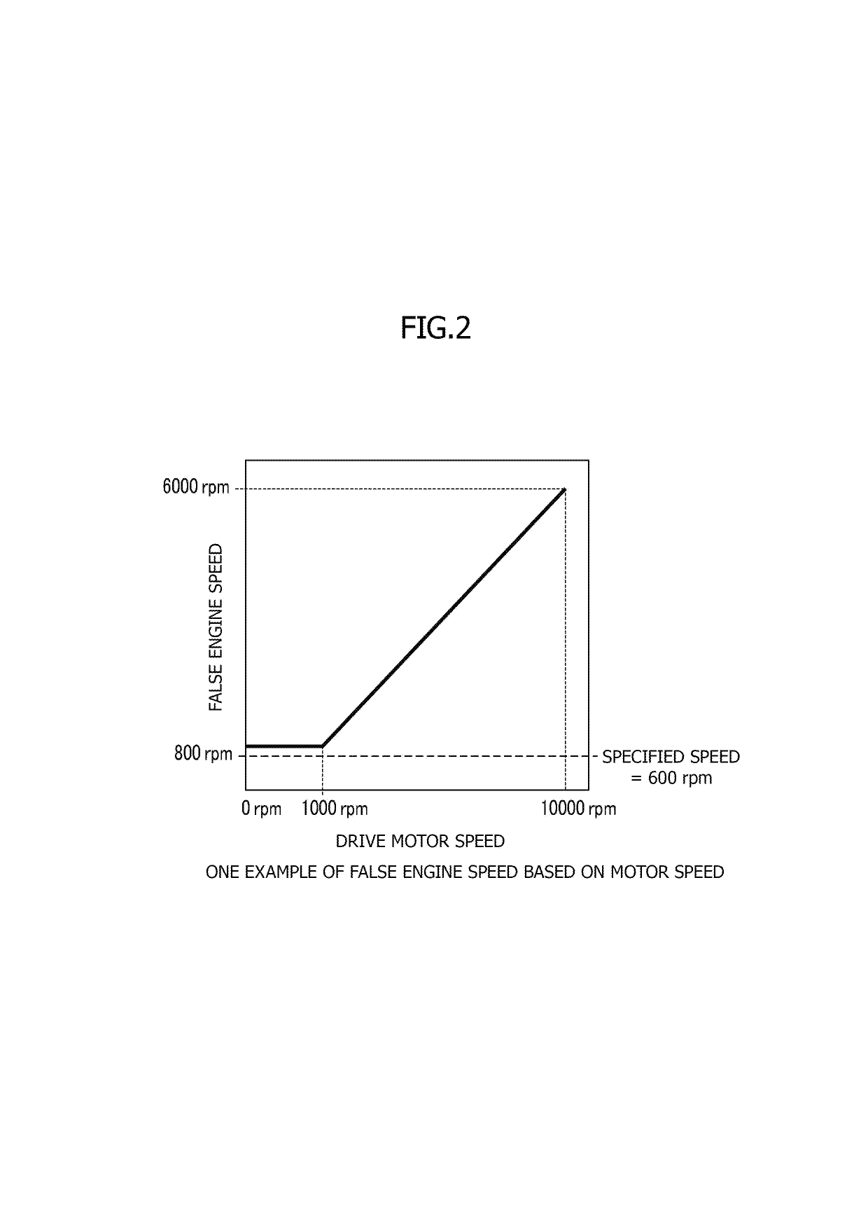

FIGS. 1 and 2 show an embodiment of the present invention.

In FIG. 1, reference sign 1 denotes a motor-driven vehicle.

This motor-driven vehicle 1 includes a drive motor 2 that is a power source for the motor-driven vehicle 1, a motor speed sensor 3 for detecting the speed of the drive motor 2, a steering system 6 for giving a steering angle to front wheels (referred also to as “driving wheels”) according to the steering angle of a steering wheel 4, a vehicle speed sensor 7 for detecting the speed of the motor-driven vehicle 1, and a power steering controller 8 that outputs an assist amount according to the steering of a passenger based on at least one of the output signals of the motor speed sensor 3 and the vehicle speed sensor 7.

Further, as shown in FIG. 1, the motor-driven vehicle 1 has the front wheels 5 and rear wheels 6, and is mounted with a driving battery 10 between the rear wheels 9.

The drive motor 2 mounted between the front wheels 5 is driven by an inverter 11 connected to the driving battery 10.

Also, the front wheel 5 is driven by the drive motor 2 via a speed reducer 12 arranged between the front wheels 5 and a drive shaft 13 connected to one front wheel 5.

The motor speed sensor 3 for detecting the speed of the drive motor 2 is provided near the drive motor 2 so as to be independent of the vehicle speed sensor 7 for measuring the rotational speed of the one front wheel 5.

Thus, the motor-driven vehicle 1 is mounted with two independent sensors of vehicle speed sensor 7 and the motor speed sensor 3 as means for estimating the vehicle speed.

The steering operation of a driver using the steering wheel 4 is transmitted to the steering system 6 arranged between the front wheels 5, whereby steering is performed. At this time, a power steering unit 14 assists the steering operation of the driver.

At this time, a vehicle driving controller 15 connected to the inverter 11 and the vehicle speed sensor 7 sends a driving torque instruction to the inverter 11 in accordance with the driver's operation performed by driving operation information such as accelerator and shift lever.

Further, the vehicle driving controller 15 calculates a vehicle speed from the vehicle speed signal sent from the vehicle speed sensor 7, and sends the calculated vehicle speed to the power steering controller 8.

This power steering controller 8 carries out assist control according to the vehicle speed signal for the power steering unit 14.

Also, the power steering controller 8 judges whether or not the state is such that the assist of steering force of the steering wheel 4 is necessary by judging whether or not the engine speed signal has exceeded the specified speed (set so as to be lower than the idling speed of engine, for example, 600 rpm).

Therefore, in an electric vehicle mounted with no engine or a series hybrid vehicle in which the vehicle speed and the engine speed are not necessarily related to each other, as a means for knowing the state such that the assist of steering force of the steering wheel 4 is necessary to the power steering controller 8, the vehicle driving controller 15 delivers a false engine speed signal not lower than the specified speed.

In a power steering system of a type in which, if the vehicle speed signal is lost, the vehicle speed state is presumed to some degree from the engine speed signal, and the fail-safe control is carried out, if the false engine speed signal takes a fixed value, the fail-safe function such that the assist control of the lowest limit is carried out according to the vehicle speed is not performed.

Accordingly, the vehicle driving controller 15 calculates the false engine speed signal based on the motor speed signal sent from the motor speed sensor 3 mounted independently of the vehicle speed sensor 7, and sends the calculated signal to the power steering controller 8.

Also, the steering system 6 of the motor-driven vehicle 1 has a configuration such that as the speed of the motor-driven vehicle 1 or the speed of the drive motor 2 increases, the assist amount is made smaller.

Specifically, as the speed of the motor-driven vehicle 1 or the speed of the drive motor 2 increases, the assist amount of steering force is made less.

Therefore, the steering system that is used for a vehicle mounted with the conventional internal combustion engine only can be used for the motor-driven vehicle such as an electric vehicle, and further steering operability equivalent to that of the vehicle mounted with the internal combustion engine can be attained.

The power steering controller 8 sets the false engine speed having a value that becomes higher with the increase in speed of the drive motor 2, and has a configuration such that when an output signal cannot be obtained from the vehicle speed sensor 7, the power steering controller 8 determines the assist amount based on the false engine speed, and when an output cannot be obtained from the motor speed sensor 3, the power steering controller 8 determines the assist amount based on the output signal sent from the vehicle speed sensor 7.

Specifically, FIG. 2 is a graph showing one example of false engine speed based on the speed of the drive motor 2.

For the engine-driven vehicle, although the relationship between vehicle speed and engine speed differs depending on the gear-change of transmission, in a high vehicle speed region, a high engine speed is attained, and in a low vehicle speed region, an idling speed is attained.

In the case shown in FIG. 2, in the region in which the drive motor speed of the drive motor 2, which correlates with the vehicle speed, is low (1000 rpm or lower in FIG. 2), the false engine speed is 800 rpm, which is about the idling speed, taking a fixed value.

Also, in the region in which the drive motor speed of the drive motor 2 exceeds 1000 rpm, the false engine speed is set so as to increase simply with the increase in the drive motor speed.

Specifically, as shown in FIG. 2, in the range of the drive motor speed of 1000 rpm corresponding to the false engine speed of 800 rpm to the drive motor speed of 10,000 rpm corresponding to the false engine speed of 6000 rpm, the drive motor speed and the false engine speed are set so as to have a relationship of increasing proportionally. The drive motor speed corresponding to the false engine speed can be changed optionally.

Therefore, the steering system used for a vehicle mounted with a conventional internal combustion engine only can be used for the motor-driven vehicle 1 such as an electric vehicle, and further the steering operability equivalent to that of the vehicle mounted with an internal combustion engine can be attained.

Also, since two systems of the output signals, each of which is a vehicle parameter for determining the assist amount of steering force, of vehicle speed and false engine speed are provided, when either one of the output signals cannot be obtained, the fail-safe control is carried out based on the other output signal sent from a normally functioning sensor, and the assist amount that is the same as that obtained in the case in which the output signals of the sensors can be obtained normally can be obtained.

The present invention is not limited to the above-described embodiment, and various changes and modifications can be made.

For example, in the embodiment of the present invention, the vehicle speed sensor is used as a device for determining the vehicle speed; however, this is one example, and any type of device for determining the vehicle speed may be used.

Also, if the vehicle speed can be detected normally, the assist amount of steering force may be determined based on the output signal of this vehicle speed. The assist amount in this case is configured so as to become smaller as the vehicle speed increases.

Further, in the case in which the output signal of vehicle speed is lost, or the output signal of motor speed is lost, and the fail-safe control is carried out, a special configuration of information display, in which an alarm of abnormality of steering system is displayed, can be used

The phrase of “the output signal of vehicle speed is lost, or the output signal of motor speed is lost” means the case in which specifically the output signal cannot be obtained on account of a failure of the vehicle speed sensor or motor speed sensor itself, the case in which the output signal sent from the sensors are not delivered to the vehicle driving controller, the power steering controller, and the like on account of wire breaking, and the like cases.

### REFERENCE SIGNS LIST

1 motor-driven vehicle
2 drive motor
3 motor speed sensor
4 steering wheel
5 front wheel (driving wheel)
6 steering system
7 vehicle speed sensor
8 power steering controller
9 rear wheel
10 driving battery
11 inverter
12 speed reducer
13 drive shaft
14 power steering unit
15 vehicle driving controller

1. A steering system for a motor-driven vehicle comprising a drive motor which is a power source for the motor-driven vehicle, a motor speed sensor for detecting the speed of the drive motor, a steering system for giving a steering angle to front wheels according to the steering angle of a steering wheel, a vehicle speed sensor for detecting the speed of the motor-driven vehicle, and a power steering controller which outputs an assist amount according to the steering of a passenger based on at least one of the output signals of the motor speed sensor and the vehicle speed sensor, characterized in that as the speed of the motor-driven vehicle or the speed of the drive motor increases, the assist amount is made smaller.

2. The steering system for a motor-driven vehicle according to claim 1, wherein the power steering controller sets a false engine speed having a value that becomes higher with the increase in speed of the drive motor, and has a configuration such that when an output signal cannot be obtained from the vehicle speed sensor, the power steering controller determines the assist amount based on the false engine speed, and when an output cannot be obtained from the motor speed sensor, the power steering controller determines the assist amount based on the output signal sent from the vehicle speed sensor.
